(19) United States
(12) Patent Application Publication
(10) Pub. No.: US 2002/0178141 A1
(43) Pub. Date: Nov. 28, 2002

(54) Method and apparatus for remote inter-language method calling

(76) Inventor: Igor Davidovich Kushnirskiy, Mountain View, CA (US)

Correspondence Address: J.D. Harriman II, COUDERT BROTHERS, 23rd Floor, 333 South Hope Street, Los Angeles, CA, 90071, US

(21) Appl. No.: 09/865,660

(22) Filed: May 25, 2001

(51) Int. Cl. G06F 7/00; G06F 17/30

(52) U.S. Cl. 707/1

(57) ABSTRACT

Embodiments of the present invention are directed towards a method and apparatus for remote inter-language method calling. In one embodiment of the present invention, remote inter-language method calls are translated into an intermediary protocol, termed “*Connect”. The call is then translated from *Connect to the protocol of the language in which the method is written. *Connect insures that the method is called properly and that any return values are returned properly. Thus, any change in the protocol of the language in which the method is written necessitates only modification of the code used to translate between *Connect and the method's language.

### BACKGROUND OF THE INVENTION

1. Field of The Invention

The present invention relates to the field of computer software, and in particular to a method and apparatus for remote inter-language method calling.

Sun, Sun Microsystems, the Sun logo, Solaris and all Java-based trademarks and logos are trademarks or registered trademarks of Sun Microsystems, Inc. in the United States and other countries. All SPARC trademarks are used under license and are trademarks of SPARC International, Inc. in the United States and other countries. Products bearing SPARC trademarks are based upon an architecture developed by Sun Microsystems, Inc.

2. Background Art

Computer programs frequently make calls to methods. Sometimes, a call is initiated in program code written in one programming language, but is made remotely to a method written in another programming language. Current methods for handling inter-language calls require the call initiating code to be rewritten if the implementation of the method being called is changed from one language to another language. This problem can be better understood by a review of remote inter-language calls.

Remote Inter-Language Calls

Sometimes it is convenient to call methods written in one programming language from code written in another programming language. For example, a web browser may provide an interface language for adding components to the web browser. The browser's interface language may handle method calls differently from the programming language in which the component is written. Thus, special code must be written to ensure that the call is made properly.

A problem arises if the implementation of the interface language is altered. The special code originally written may no longer work correctly. Thus, the special code must be rewritten for the method to be properly called. Additionally, special code must be written for each programming language that calls the method. For example, code must be written to allow Java code to call an XPCOM method in addition to code to allow UNO code to call an XPCOM method if one component is coded in Java, a second component is coded in UNO and the method is coded in XPCOM. However, if the XPCOM protocols are altered, both the code to call XPCOM methods from Java code and the code to call XPCOM methods from UNO code must be rewritten.

### SUMMARY OF THE INVENTION

Embodiments of the present invention are directed towards a method and apparatus for remote inter-language method calling. In one embodiment of the present invention, remote inter-language method calls are translated into an intermediary protocol, termed “*Connect”. The call is then translated from *Connect to the protocol of the language in which the method is written. *Connect insures that the method is called properly and that any return values are returned properly. Thus, any change in the protocol of the language in which the method is written necessitates only modification of the code used to translate between *Connect and the method's language.

### BRIEF DESCRIPTION OF THE DRAWINGS

These and other features, aspects and advantages of the present invention will become better understood with regard to the following description, appended claims and accompanying drawings where:

FIG. 1 is a flow diagram of the process of remotely calling a method in accordance with one embodiment of the present invention.

FIG. 2 is a block diagram of a system wherein remote calls to methods written in Java, XPCOM or UNO may be called from code written in Java, XPCOM or UNO.

FIG. 3 is a block diagram of the interfaces of a *Connect module in accordance with one embodiment of the present invention.

FIG. 4 is a block diagram of an invocation scenario in accordance with one embodiment of the present invention.

FIG. 5 is a block diagram of an XPCOM module in accordance with one embodiment of the present invention.

FIG. 6 is a block diagram of a Java module in accordance with one embodiment of the present invention.

FIG. 7 is a block diagram of a general purpose computer.

### DETAILED DESCRIPTION OF THE INVENTION

The invention is a method and apparatus for remote inter-language method calling. In the following description, numerous specific details are set forth to provide a more thorough description of embodiments of the invention. It is apparent, however, to one skilled in the art, that the invention may be practiced without these specific details. In other instances, well known features have not been described in detail so as not to obscure the invention.

Intermediary Protocol

In one embodiment of the present invention, remote inter-language method calls are translated into an intermediary protocol, termed “*Connect”. The call is then translated from *Connect to the protocol of the language in which the method is written. *Connect insures that the method is called properly and that any return values are returned properly.

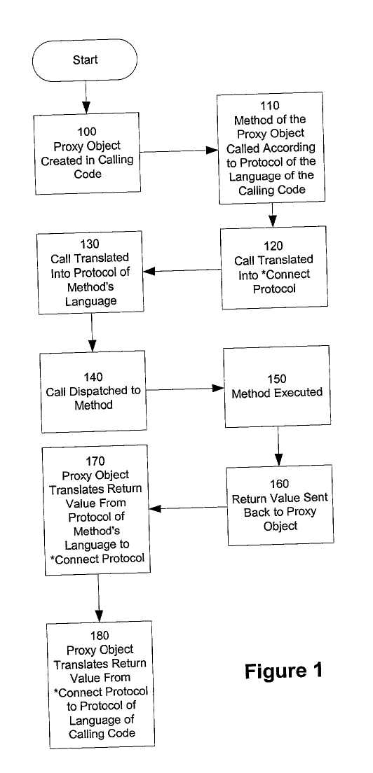

FIG. 1 illustrates the process of remotely calling a method in accordance with one embodiment of the present invention. At step 100, a proxy object is created in the calling code. The proxy object translates calls from the language of the calling code to the *Connect protocol. At step 110, a method of the proxy object is called according to the protocol of the language of the calling code. At step 120, the call is translated into the *Connect protocol. At step 130, the call is translated, or marshaled, into the protocol of the method's language. At step 140, the call is dispatched to the method. At step 150, the method is executed. At step 160, the return value is sent back to the proxy object. At step 170, the proxy object translates the return value from the protocol of the method's language to the *Connect protocol. At step 180, the proxy object translates the return value from the *Connect protocol to the protocol of the language of the calling code.

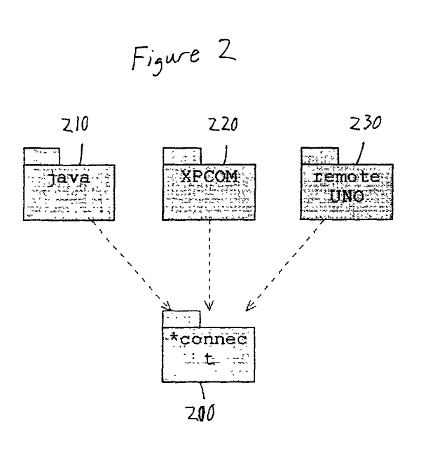

In one embodiment, many programming languages are able to remotely call methods written in other programming languages. Each language has a translation from the language to *Connect and from *Connect to the language. FIG. 2 illustrates a system wherein remote calls to methods written in Java, XPCOM or UNO may be called from code written in Java, XPCOM or UNO. A *Connect module 200 provides a standard interface for method calls. A Java module 210 translates between the Java protocol and the *Connect protocol. An XPCOM module 220 translates between the XPCOM protocol and the *Connect protocol. Similarly, an UNO module 230 translates between the UNO protocol and the *Connect protocol.

Since remote calls to a method are first translated into *Connect, any change in the language in which the method is written necessitates only modification of the code used to translate between *Connect and the method's language. Thus, the code which remotely calls the function does not need to be altered.

*Connect Module

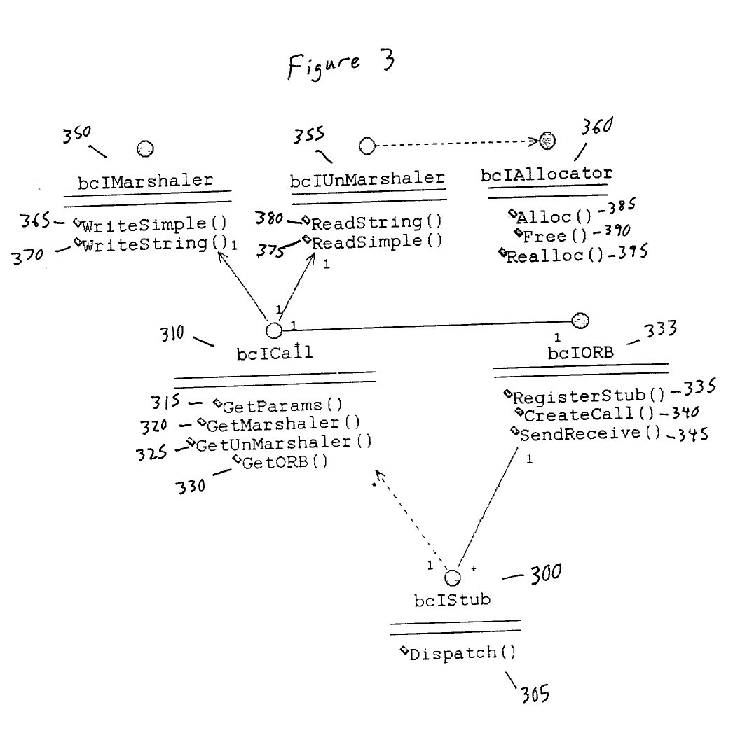

FIG. 3 illustrates the interfaces of a *Connect module in accordance with one embodiment of the present invention. The *Connect module contains a bcIStub data structure 300. The bcIStub data structure has a Dispatch 305 member function. The bcIStub data structure hides object details from the caller. Since bcIStub handles invocation, it does not matter was used for object implementation. There is a different bcIStub implementation for each programming language in the system. For example, in the system of FIG. 2, there are implementations for Java, UNO and XPCOM.

The *Connect module also contains a bcICall data structure 310 which has GetParams 315, GetMarshaler 320, GetUnMarshaler 325 and GetORB 330 member functions. bcICall represents a calling stack slice. Thus, all arguments for calling a method are placed in bcIcall. Additionally, results from invocation of the method are placed in bcICall. In one embodiment, all data in bcICall is placed by value.

A bcIORB data structure 333 is included in the *Connect module. bcIORB is used to registering bcIStub, assigning a unique object identifier and invoking objects. bcIORB also has RegisterStub 335, CreateCall 340 and SendReceive 345 member functions.

The *Connect module also contains bcIMarshaler 350, bcIUnMarshaler 355, and bcIAllocator 360 data structures as helpers for bcICall. bcIarshaler has WriteSimple 365 and WriteString 370 member functions. Correspondingly, bcIUnMarshaler has ReadSimple 375 and ReadString 380 member functions. bcIAllocator has Alloc 385, Free 390 and Realloc 395 member functions.

Invocation Scenario

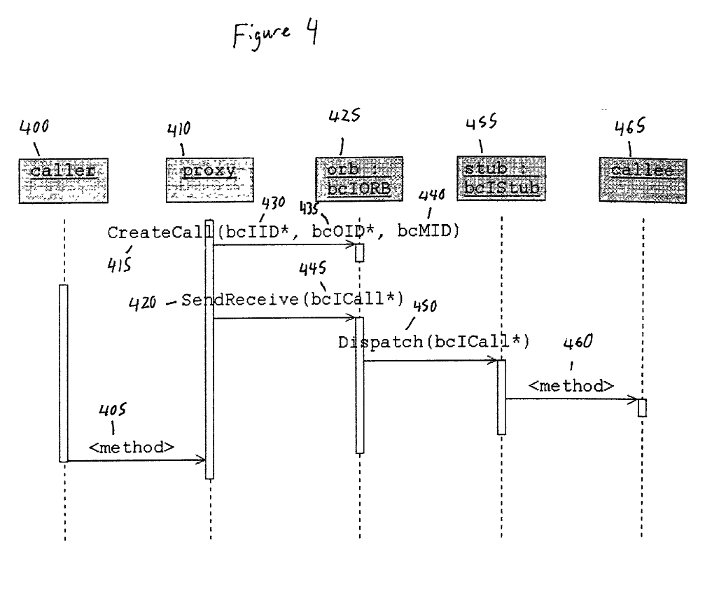

FIG. 4 illustrates an invocation scenario in accordance with one embodiment of the present invention. A caller 400 sends the method call 405 to a proxy 410. A call to CreateCall 415 and to SendReceive 420 is sent to the orb 425. The CreateCall call has parameters bcJID 430, bcOID 435 and bcMID 440. bcffD is a unique interface identifier. bcOID is a unique object identifier, and bcMID is a method identifier. The SendReceive call has bcICall 445 as a parameter. bcICall represents a calling stack slice. Thus, all parameters and return values are placed in bcICall. The CreateCall and SendReceive calls and their parameters are details that are completely hidden from the caller.

orb calls the Dispatch 450 function of stub 455 with bcICall as a parameter. Then, stub calls the implementation of the method 460 at the callee 465 and the method is executed.

XPCOM Module

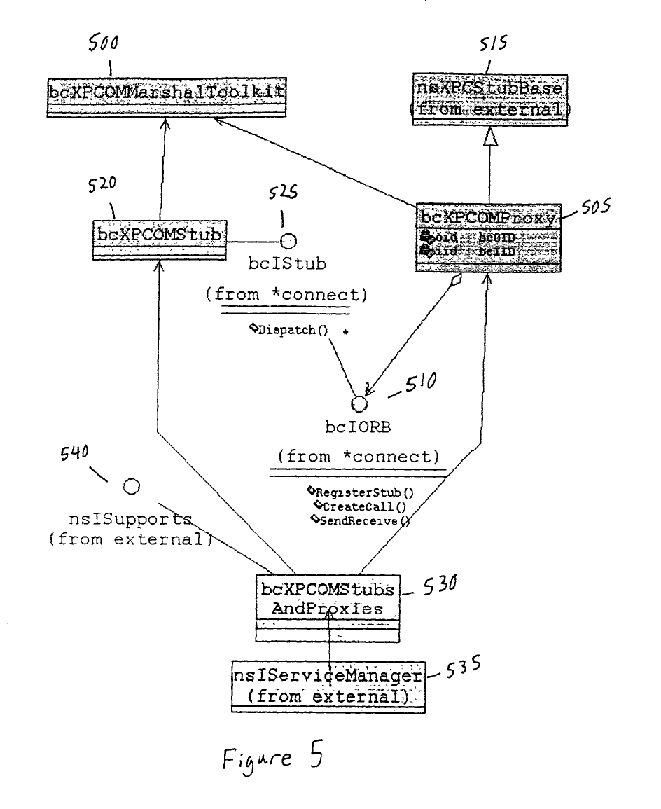

FIG. 5 illustrates an XPCOM module in accordance with one embodiment of the present invention. The bcXPCOMMarshalToolkit data structure 500 is responsible for marshaling and unmarshaling and uses XPCOM typelibs for obtaining information about interface signatures. bcXPCOMProxy 505 is a proxy object and is called exactly like any other XPCOM object. Additionally, bcXPCOMProxy can act as a proxy for any XPCOM interface. bcXPCOMProxy has member variables oid and iid and can issue calls to bcIORB 510 from the *Connect module. bcXPCOMProxy also interacts with nsXPCStubBase 515.

bcXPCOmStub 520 is associated with bcIStub 525 from the *Connect module and uses XPTC_InvokeByIndex for dynamic method invocation. bcXpCOMStubsAndProxies 530 is an XPCOM service for creating bcXPCOMStubs and bcXPCOMProxies. bcXPCOMStubsAndProxies also interacts with nsIServiceManager 535 and nsISupports 540.

In one embodiment, bcXPCOMStub ensures that XPCOM objects are called from a safe thread. The object is safe to call in the thread on which bcXPCOMStub is created. Therefor, when bcXPCOMStub is created, ThreadID is saved in bcXPCOMStub. When the object is called, the current thread ID is compared to the thread ID saved in bcXPCOMStub. If the thread IDs are equal, the call is executed. If the thread IDs are not equal, nsIEventQueue is used to send the request to the thread in which the stub was created.

In one embodiment, a stack of thread IDs is maintained in a thread's local storage. Every time bcXPCOMStub is called, it stores the current thread ID in the local storage of the thread from which it was executed. When the call to bcXPCOMStub concludes, bcXPCOMStub removes the thread ID from the local storage. When bcXPCOMProxy is called, the thread ID from the current thread local storage is retrieved and it is determined whether the current thread ID is equal to the loaded thread ID. If the two thread IDs are equal, the call is executed. If the two threads IDs are not equal, nsIEventQueue is used to send the request for execution in the thread with the loaded thread ID.

Java Module

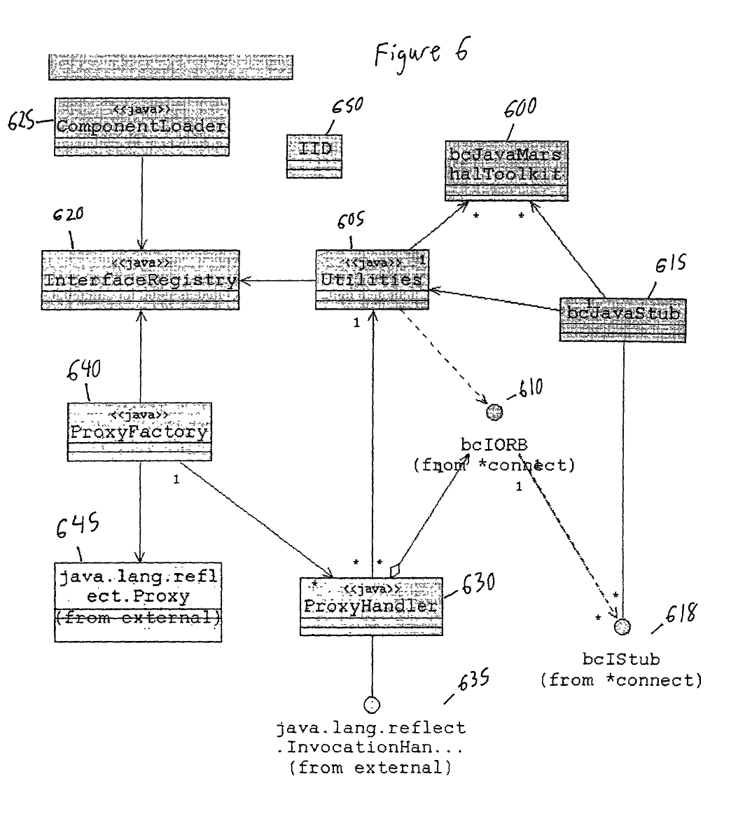

FIG. 6 illustrates a Java module in accordance with one embodiment of the present invention. bcJavaMarshalToolkit 600 is responsible for marshaling an unmarshaling. Utilities 605 is responsible for low level interactions (e.g., invocation by oid, iid or mid). Utilities also interacts with bcIORB 610 from *Connect and bcJavaStub 615. bcavaStub also interacts with bcIStub 618 from *Connect. InterfaceRegistry 620 is responsible for interface registration, mapping bcIID to java.lang.Class, mapping bcMID to java.lang.reflect.Method and mapping java.lang.reflect.method to bcMID. InterfaceRegistry also interacts with ComponentLoader 625. ProxyHandler 630 is a handler for a java proxy and has information about the object it wraps (e.g., oid and iid). ProxyHandler also interacts with java.lang.reflect.InvocationHandler 635 and bcIORB from *Connect. ProxyFactory 640 produces java proxies and interacts with java.lang.reflect.Proxy 645. The Java module also had an IID data structure 650.

Netscape6/Mozilla and Java

One embodiment enables interoperability between Java and XPCOM components. One embodiment enables users to implement components for the Netscape6/Mozilla browser in Java. Another embodiment enables the use of native Netscape6/Mozilla components in Java applications.

Embodiment of Computer Execution Environment (Hardware)

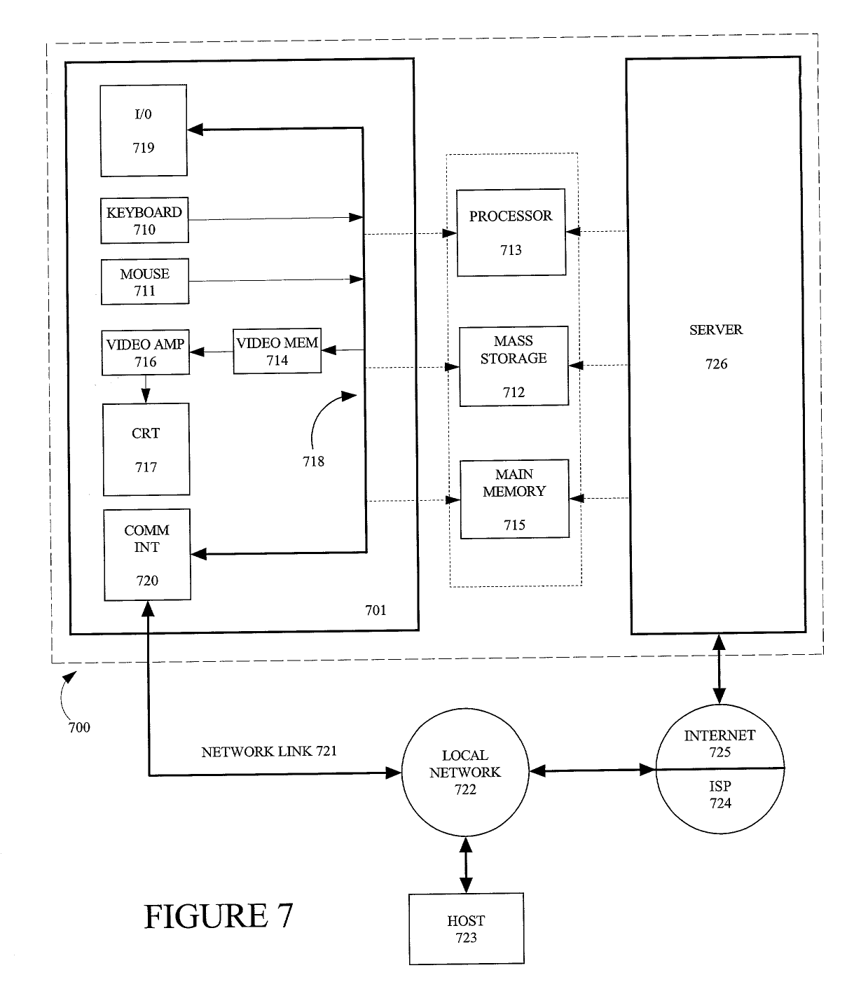

An embodiment of the invention can be implemented as computer software in the form of computer readable program code executed in a general purpose computing environment such as environment 700 illustrated in FIG. 7, or in the form of bytecode class files executable within a Java™ run time environment running in such an environment, or in the form of bytecodes running on a processor (or devices enabled to process bytecodes) existing in a distributed environment (e.g., one or more processors on a network). A keyboard 710 and mouse 711 are coupled to a system bus 718. The keyboard and mouse are for introducing user input to the computer system and communicating that user input to central processing unit (CPU) 713. Other suitable input devices may be used in addition to, or in place of, the mouse 711 and keyboard 710.I/O (input/output) unit 719 coupled to bi-directional system bus 718 represents such I/O elements as a printer, A/V (audio/video) I/O, etc.

Computer 701 may include a communication interface 720 coupled to bus 718. Communication interface 720 provides a two-way data communication coupling via a network link 721 to a local network 722. For example, if communication interface 720 is an integrated services digital network (ISDN) card or a modem, communication interface 720 provides a data communication connection to the corresponding type of telephone line, which comprises part of network link 721. If communication interface 720 is a local area network (LAN) card, communication interface 720 provides a data communication connection via network link 721 to a compatible LAN. Wireless links are also possible. In any such implementation, communication interface 720 sends and receives electrical, electromagnetic or optical signals which carry digital data streams representing various types of information.

Network link 721 typically provides data communication through one or more networks to other data devices. For example, network link 721 may provide a connection through local network 722 to local server computer 723 or to data equipment operated by ISP 724. ISP 724 in turn provides data communication services through the world wide packet data communication network now commonly referred to as the “Internet” 725. Local network 722 and Internet 725 both use electrical, electromagnetic or optical signals which carry digital data streams. The signals through the various networks and the signals on network link 721 and through communication interface 720, which carry the digital data to and from computer 700, are exemplary forms of carrier waves transporting the information.

Processor 713 may reside wholly on client computer 701 or wholly on server 726 or processor 713 may have its computational power distributed between computer 701 and server 726. Server 726 symbolically is represented in FIG. 7 as one unit, but server 726 can also be distributed between multiple “tiers”. In one embodiment, server 726 comprises a middle and back tier where application logic executes in the middle tier and persistent data is obtained in the back tier. In the case where processor 713 resides wholly on server 726, the results of the computations performed by processor 713 are transmitted to computer 701 via Internet 725, Internet Service Provider (ISP) 724, local network 722 and communication interface 720. In this way, computer 701 is able to display the results of the computation to a user in the form of output.

Computer 701 includes a video memory 714, main memory 715 and mass storage 712, all coupled to bi-directional system bus 718 along with keyboard 710, mouse 711 and processor 713. As with processor 713, in various computing environments, main memory 715 and mass storage 712, can reside wholly on server 726 or computer 701, or they may be distributed between the two. Examples of systems where processor 713, main memory 715, and mass storage 712 are distributed between computer 701 and server 726 include the thin-client computing architecture developed by Sun Microsystems, Inc., the palm pilot computing device and other personal digital assistants, Internet ready cellular phones and other Internet computing devices, and in platform independent computing environments, such as those which utilize the Java technologies also developed by Sun Microsystems, Inc.

The mass storage 712 may include both fixed and removable media, such as magnetic, optical or magnetic optical storage systems or any other available mass storage technology. Bus 718 may contain, for example, thirty-two address lines for addressing video memory 714 or main memory 715. The system bus 718 also includes, for example, a 32-bit data bus for transferring data between and among the components, such as processor 713, main memory 715, video memory 714 and mass storage 712. Alternatively, multiplex data/address lines may be used instead of separate data and address lines.

In one embodiment of the invention, the processor 713 is a SPARC microprocessor from Sun Microsystems, Inc., a microprocessor manufactured by Motorola, such as the 680×0 processor, or a microprocessor manufactured by Intel, such as the 80×86 or Pentium processor. However, any other suitable microprocessor or microcomputer may be utilized. Main memory 715 is comprised of dynamic random access memory (DRAM). Video memory 714 is a dual-ported video random access memory. One port of the video memory 714 is coupled to video amplifier 716. The video amplifier 716 is used to drive the cathode ray tube (CRT) raster monitor 717. Video amplifier 716 is well known in the art and may be implemented by any suitable apparatus. This circuitry converts pixel data stored in video memory 714 to a raster signal suitable for use by monitor 717. Monitor 717 is a type of monitor suitable for displaying graphic images.

Computer 701 can send messages and receive data, including program code, through the network(s), network link 721, and communication interface 720. In the Internet example, remote server computer 726 might transmit a requested code for an application program through Internet 725, ISP 724, local network 722 and communication interface 720. The received code may be executed by processor 713 as it is received, and/or stored in mass storage 712, or other non-volatile storage for later execution. In this manner, computer 700 may obtain application code in the form of a carrier wave. Alternatively, remote server computer 726 may execute applications using processor 713, and utilize mass storage 712, and/or video memory 715. The results of the execution at server 726 are then transmitted through Internet 725, ISP 724, local network 722 and communication interface 720. In this example, computer 701 performs only input and output functions.

Application code may be embodied in any form of computer program product. A computer program product comprises a medium configured to store or transport computer readable code, or in which computer readable code may be embedded. Some examples of computer program products are CD-ROM disks, ROM cards, floppy disks, magnetic tapes, computer hard drives, servers on a network, and carrier waves.

The computer systems described above are for purposes of example only. An embodiment of the invention may be implemented in any type of computer system or programming or processing environment.

Thus, a method and apparatus for remote inter-language method calling is described in conjunction with one or more specific embodiments. The invention is defined by the following claims and their full scope and equivalents.

1. A method for remote inter-language method calling comprising:
issuing a method call using a first protocol;
translating said method call from said first protocol to an intermediary protocol; and
translating said method call from said intermediary protocol to a second protocol.

2. The method of claim 1 wherein said first step of translating comprises:
calling a proxy object.

3. The method of claim 1 wherein said first protocol is selected from the group of Java, XPCOM and UNO.

4. The method of claim 1 wherein said intermediary protocol is *Connect.

5. The method of claim 1 wherein said second protocol is selected from the group of Java, XPCOM and UNO.

6. A remote inter-language method calling system comprising:
a method calling unit configured to issue a method call using a first protocol;
a first translator configured to translate said method call from said first protocol to an intermediary protocol; and
a second translator configured to translate said method call from said intermediary protocol to a second protocol.

7. The remote inter-language method calling system of claim 6 wherein said first translator comprises:
a proxy object.

8. The remote inter-language method calling system of claim 6 wherein said first protocol is selected from the group of Java, XPCOM and UNO.

9. The remote inter-language method calling system of claim 6 wherein said intermediary protocol is *Connect.

10. The remote inter-language method calling system of claim 6 wherein said second protocol is selected from the group of Java, XPCOM and UNO.

11. A computer program product comprising:
a computer usable medium having computer readable program code embodied therein configured for remote inter-language method calling, comprising:
computer readable code configured to cause a computer to issue a method call using a first protocol;
computer readable code configured to cause a computer to translate said method call from said first protocol to an intermediary protocol; and
computer readable code configured to cause a computer to translate said method call from said intermediary protocol to a second protocol.

12. The computer program product of claim 6 wherein said computer readable code configured to cause a computer to translate said method call from said first protocol comprises:
computer readable code configured to cause a computer to call a proxy object.

13. The computer program product of claim 6 wherein said first protocol is selected from the group of Java, XPCOM and UNO.

14. The computer program product of claim 6 wherein said intermediary protocol is *Connect.

15. The computer program product of claim 6 wherein said second protocol is selected from the group of Java, XPCOM and UNO.
